(19) United States
(12) Patent Application Publication
(10) Pub. No.: US 2019/0354925 A1
(43) Pub. Date: Nov. 21, 2019

(54) Global Unique Identifier of Logistics Object

(71) Applicant: Telefonaktiebolaget LM Ericsson (publ), Stockholm (SE)

(72) Inventors: Hasse Römer, Ekerö (SE); Herman Van Rens, Bavel AC (NL)

(21) Appl. No.: 16/478,985

(22) PCT Filed: Feb. 21, 2018
(86) PCT No.: PCT/EP2018/054257

§ 371 Date: Jul. 18, 2019

Related U.S. Application Data
(60) Provisional application No. 62/461,755, filed on Feb. 21, 2017.

(51) Int. Cl. G06Q 10/08; G06F 16/955

(52) U.S. Cl. CPC G06Q 10/087; G06F 16/9566

(57) ABSTRACT

A logistics backbone system (10) is configured to receive a request (16) for information related to a logistics object (12) (e.g., a transport unit, a product, a product package, a freight container, or a movement vehicle). The logistics object (12) may be identified by a globally unique identifier (12A) in the form of a uniform resource identifier (URI). The request (16) may be addressed to the URI in some embodiments. The URI may be formed for example from an identifier (14A) of the logistics backbone system (10), an identifier (14B) of the logistics object (12), and an identifier (14C) of an issuer that issued the identifier (14B) of the logistics object (12). The logistics backbone system (10) is further configured to respond to the request (16) with information (18) related to the logistics object (12).

### BACKGROUND

A typical supply chain usually consists of several operators such as one or more operators for manufacturing, one or more operators for distribution, one or more operators for transport, etc. This may be the case very often in a multi-modal situation, for example where a product is transported via truck-air-truck, or truck-sea-truck, and so on. Thus, there is most often a multitude of parties involved in order to transport products from a manufacturing site to consumption of the product.

Furthermore, in a supply chain, one would consolidate and un-consolidate cargo as it moves further to the destination in order to optimize resource utilization. As an example, several boxes will go on a pallet, several pallets in a container, and a container on a boat. Later on, the boat will be un-loaded, containers put on trucks for distribution centers, and in the distribution centers the containers are emptied and new load configurations made for the last-mile delivery. The result is that it is difficult to track cargo.

The present solution for digital collaboration and integration is mainly using different kinds of electronical documents, passing between in a peer-to-peer setup. Examples are EDIFACT and RosettaNet, which are all based on this peer-to-peer setup between different companies' information technology (IT) systems.

In addition, at present each entity in the supply chain uses their own reference identifier in accordance to the ISO15459 standard. This standard describes how to label transport units in order to provide identifiers for the logistic operations. However, the identification is limited to Company & Transport Unit number. Globally, there is a multitude of different implementations. The standard is implemented using either Barcodes, Quick Response (QR) codes, radio frequency identification (RFID), or other smart labels.

Implemented in this way, known approaches to identification and/or supply chain logistics prove inefficient in that many records are duplicated, are prone to errors, require manual intervention, and prove limited in their usefulness.

### SUMMARY

One or more embodiments herein include a logistics backbone system. The system may be configured to exploit a globally unique identifier of a logistics object (e.g., a transport unit) as described herein, e.g., in order to provide information about that logistics object to requesting parties or devices. The logistics backbone system in this regard may be decentralized, e.g., in the sense that it is just one of multiple logistics backbone systems (e.g., in different “clouds”) that provide logistics object information. At least some different logistics backbone systems may in one embodiment provide logistics object information for logistics objects at different logistics hierarchical levels (e.g., transport unit level vs. carrier level).

More particularly, embodiments herein include a method performed by a logistics backbone system according to some embodiments. The method comprises receiving at the logistics backbone system a request for information related to a logistics object (e.g., a transport unit, a product, a product package, a freight container, or a movement vehicle). The requested information related to the logistics object may be for instance information describing content of the logistics object, information describing handling instructions for the logistics object, information describing a source and/or destination of the logistics object, information describing a route taken by the logistics object, or information describing a status of an event related to the logistics object. Regardless, the logistics object may be identified by a globally unique identifier in the form of a uniform resource identifier (URI). The request may be addressed to the URI in some embodiments. The URI may be formed for example from an identifier of the logistics backbone system, an identifier of the logistics object, and an identifier of an issuer that issued the identifier of the logistics object. In some embodiments, the method further comprises responding to the request with information related to the logistics object.

In some embodiments, the method may comprise retrieving the information related to the logistics object from a database of the logistics backbone system. In some embodiments, for instance, the method may comprise retrieving from a database of the logistics backbone system information that is related to the logistics object by way of the information describing the logistics object itself.

Alternatively or additionally, the method may comprise retrieving the information related to the logistics object from another logistics backbone system. This may be the case for instance in some embodiments where the logistics backbone system is one of multiple decentralized logistics backbone system. In one embodiment, at least some of these multiple decentralized logistics backbone systems provides logistics information for multiple different logistics hierarchical levels, respectively. In these and other embodiments, then, the method may comprise retrieving from another logistics backbone system information that is related to the logistics object by way of the information describing another logistics object that is hierarchically related to the logistics object.

More particularly, in some embodiments, the method further comprises determining that the logistics object is hierarchically related to another logistics object that is also identified by a globally unique identifier in the form of a URI. In this case, the method may also comprise obtaining information related to the another logistics object using the globally unique identifier of that another logistics object. In some embodiments, for instance, obtaining the information related to the another logistics object may involve sending, from the logistics backbone system to another logistics backbone system, a request for information related to the another logistics object, the request addressed to the URI that forms the globally unique identifier of the another logistics object. The obtaining may further involve receiving, at the logistics backbone system from the another logistics backbone system, the information related to the another logistics object in response to sending the request. No matter how the information related to the another logistics object is obtained, though, the information with which the logistics backbone system responds to the request may include or be determined from the information related to the another logistics object.

Embodiments herein also include a method performed by an end device (e.g., a scanner or user equipment, UE) according to some embodiments. The method may comprise sending to a logistics backbone system a request for information related to a logistics object (e.g., a transport unit, a product, a product package, a freight container, or a movement vehicle). The requested information related to the logistics object may be for instance information describing content of the logistics object, information describing handling instructions for the logistics object, information describing a source and/or destination of the logistics object, information describing a route taken by the logistics object, or information describing a status of an event related to the logistics object. Regardless, the logistics object may be identified by a globally unique identifier in the form of a uniform resource identifier (URI). The request may be addressed to the URI in some embodiments. The URI may be formed for instance from an identifier of the logistics backbone system, an identifier of the logistics object, and an identifier of an issuer that issued the identifier of the logistics object. The method may further comprise, responsive to the request, receiving information related to the logistics object.

In some embodiments, the information is related to the logistics object by way of the information describing the logistics object itself. Alternatively or additionally, the information may be related to the logistics object by way of the information describing another logistics object that is hierarchically related to the logistics object. This may be the case for instance in some embodiments where the logistics backbone system is one of multiple decentralized logistics backbone system. In one embodiment, at least some of these multiple decentralized logistics backbone systems provide logistics information for multiple different logistics hierarchical levels, respectively.

In fact, in some embodiments, the information related to the logistics object includes a globally unique identifier of another logistics object to which the logistics object is hieratically related (e.g., as a parent or child of the logistics object). For example, the globally unique identifier of the another logistics object may comprise a URI formed from an identifier of the same or a different logistics backbone system, an identifier of the another logistics object, and an identifier of an issuer that issued the identifier of the another logistics object. Regardless, the method in these cases may further comprise sending a request to another logistics backbone system to retrieve information that is related to another logistics object.

Additional embodiments include a corresponding apparatus, computer program, computer program product, and the like. For example, embodiments include a logistics backbone system (e.g., comprising communication circuitry and processing circuitry). The logistics backbone system is configured to receive at the logistics backbone system a request for information related to a logistics object (e.g., a transport unit, a product, a product package, a freight container, or a movement vehicle). The logistics object may be identified by a globally unique identifier in the form of a uniform resource identifier (URI). The request may be addressed to the URI in some embodiments. The URI may be formed for example from an identifier of the logistics backbone system, an identifier of the logistics object, and an identifier of an issuer that issued the identifier of the logistics object. In some embodiments, the logistics backbone system is further configured to respond to the request with information related to the logistics object.

Embodiments also include an end device (e.g., comprising communication circuitry and processing circuitry). The end device may be configured to send to a logistics backbone system a request for information related to a logistics object (e.g., a transport unit, a product, a product package, a freight container, or a movement vehicle). The logistics object may be identified by a globally unique identifier in the form of a uniform resource identifier (URI). The request may be addressed to the URI in some embodiments. The URI may be formed for instance from an identifier of the logistics backbone system, an identifier of the logistics object, and an identifier of an issuer that issued the identifier of the logistics object. The end device may further be configured to, responsive to the request, receive information related to the logistics object.

Some embodiments enable a global reference of logistic identifiers that in turn enable an ecosystem for connected logistics, building on existing internet infrastructure and technology. Furthermore, some embodiments provide a decentralized open platform enabling competition and cooperation within the supply chain for the benefit of all involved parties. Additionally, some embodiments add real-time information sharing without cascading sequential business-to-business connectivity. The business-to-business integration need would also greatly decrease since in some embodiments an entity only need to connect to one connected logistics backbone to have all other actors connected. All these points will lead to greater efficiency, higher quality and lower costs for logistic companies.

### BRIEF DESCRIPTION OF THE DRAWINGS

FIG. 1 is a block diagram of a logistics backbone system according to some embodiments.

FIG. 2 is a logic flow diagram of a method performed by a logistics backbone system according to some embodiments.

FIG. 3 is a logic flow diagram of a method performed by an end device according to some embodiments.

FIG. 4 is a block diagram of consolidation in a logistics chain according to some embodiments.

FIG. 5 is a block diagram of an example of a globally unique identifier according to some embodiments.

FIG. 6 is a block diagram of an example of a hierarchy of globally unique identifiers according to some embodiments.

FIG. 7 is a block diagram of an example of a hierarchy of globally unique identifiers according to other embodiments.

FIG. 8 is a block diagram of a multi-cloud environment according to some embodiments.

FIG. 9A is a block diagram of a logistics backbone system according to some embodiments.

FIG. 9B is a block diagram of a logistics backbone system according to other embodiments.

FIG. 10A is a block diagram of an end device according to some embodiments.

FIG. 10B is a block diagram of an end device according to other embodiments.

### DETAILED DESCRIPTION

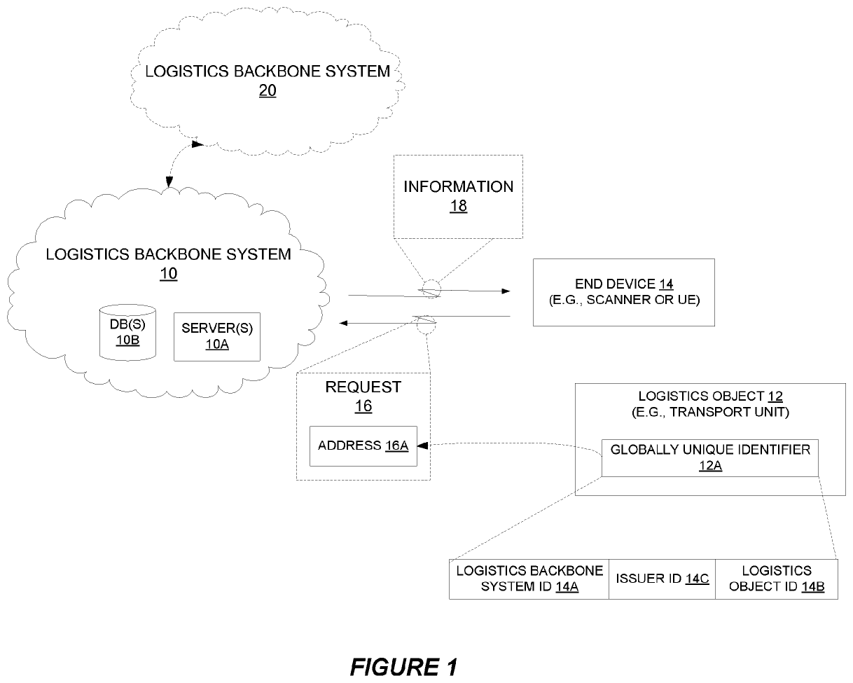

FIG. 1 shows a logistics backbone system 10 according to some embodiments. As shown, the system 10 may include one or more server(s) 10A and one or more databases 10B. The system 10 in this and other configurations may be open or otherwise accessible, e.g., via the Internet, for providing information related to a logistics object 12 to a requesting entity or party. FIG. 1 shows for example a requesting entity or party as being associated with or in the form of an end device 14 (e.g., a scanner or user equipment, UE). In this way, the system 10 may be operate as a sort of backbone for different entities or parties to get information related to logistics objects, e.g., so as to effectively interconnect those different entities or parties.

The logistics object 12 is any physical or informational object associated with logistics, e.g., of a supply chain. In some embodiments, for example, the logistics object 12 may be a product, a product's packaging, a transport unit (e.g., an unbreakable unit via which one or more products are transported), a freight container, or a movement vehicle (e.g., a truck, airplane, ship, or train). According to some embodiments, the logistics object 12 is identified by a globally unique identifier 12A. The identifier 12A may be globally unique in the sense that it uniquely identifies the logistics object 12 as distinguished from any other logistics objects in the world. This identifier 12A may be printed on, encoded on, or otherwise associated with the logistics object 12 itself (e.g., in the form of a Quick Response (QR) code on a label affixed to the object 12). An end device 14 may thereby scan the identifier 12 in order to identify the logistics object 12, e.g., for tracking its movement along the supply chain.

The globally unique identifier 12A according to some embodiments notably takes the form of a uniform resource identifier (URI). This URI may identify a resource or location where information 18 related to the logistics object 12 may be retrieved. Such information 18 may include information directly related to the logistics object 12 (e.g., in the sense that it describes the logistics object 12 itself) or may include information indirectly related to the logistics object 12 (e.g., in the sense that it describes another logistics object that is (hierarchically) related to the logistics object 12). No matter the particular nature of the information 18, the URI in some embodiments identifies a particular logistics backbone system 10 as being the location where information 18 related to the logistics object 12 may be retrieved.

FIG. 1 in this regard shows that the globally unique identifier 12A may be formed from a logistics backbone system identifier 14A, an identifier 14B of the logistics object 12, and an identifier 14C of an issuer that issued the identifier 14B of the logistics object 12. The identifier 14B of the logistics object 12 may for instance be non-unique across different issuers, but unique with regard to the particular issuer identified by identifier 14C. When identifiers 14B and 14C are coupled with the logistic backbone system identifier 14A, the globally unique identifier 12A (e.g., in the form of a URI) may effectively point to the logistics backbone system 10 as the source of information related to that uniquely identified logistics object 12.

Accordingly, the logistics backbone system 10 in some embodiments herein is configured to or capable of exploiting the globally unique identifier 12A of the logistics object 12, in order to provide information related to the logistics object 12. In this regard, the system 10 may be configured to receive a request 16 for information related to the logistics object 12 that is identified by the globally unique identifier 12A in the form of a URI. With the URI pointing to the system 10 as the source of such information, the request 16 in some embodiments may be addressed to that URI (e.g., an address 16A of the request may be or be based on the URI). In some embodiments, the request may amount to an HTTP request for retrieval of web content associated with the URI. Regardless, the system 10 may respond to the request with information 18 related to the logistics object.

Where the information 18 includes information directly related to the logistics object 12 (e.g., in the sense that it describes the logistics object 12 itself), the information may include one or more of: information describing content of the logistics object (e.g., a certain product); information describing handling instructions for the logistics object; information describing a source and/or destination of the logistics object; information describing a route taken by the logistics object; or information describing a status of an event related to the logistics object.

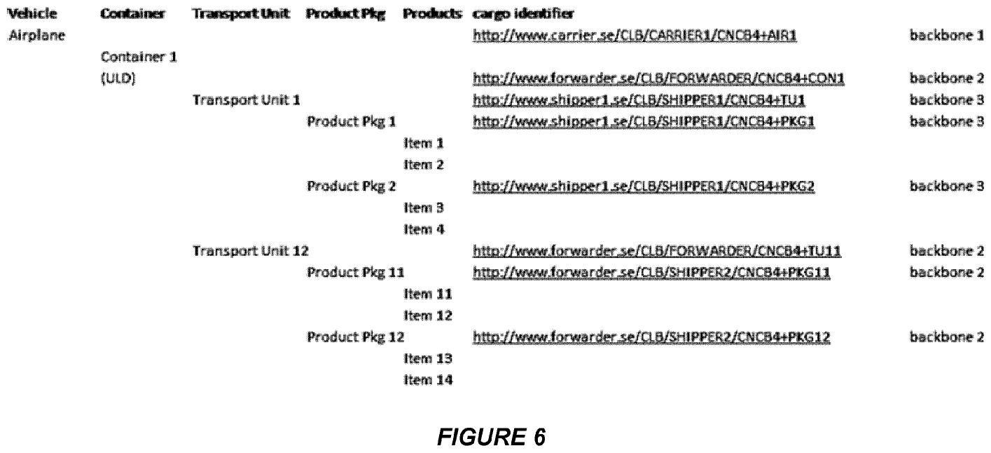

Alternatively or additionally, the information 18 may be indirectly related to the logistics object 12, e.g., in the sense that it describes another logistics object that is (hierarchically) related to the logistics object 12. In this regard, the globally unique identifier 12A and thereby the logistics object 12 may be hierarchically related to another globally unique identifier of another logistics object, e.g., according to a hierarchy of logistics objects within a supply chain. As an example, where the logistics object 12 is a transport unit, the logistics object 12 may be hierarchically related to another logistics object in the form of a container at a higher hierarchical level or a product package at a lower hierarchical level (as explained further below with reference to FIG. 6). The information 18 in some embodiments may therefore include information related to this other logistics object.

In some embodiments, the logistics backbone system 10 is a decentralized system in the sense that it is just one of multiple logistics backbone systems, such that information related to logistics objects is distributed amongst multiple backbone systems, rather than being centralized at a single system. In this and other cases, the logistics backbone system 10 may retrieve information related to another hierarchically related logistics object from another logistics backbone system (e.g., system 20), as part of responding to a request for information related to logistics object 12.

For example, the system 10 may determine that the logistics object 12 is hierarchically related to another logistics object that is also identified by a globally unique identifier in the form of a URI, and obtain information related to the another logistics object using the globally unique identifier of that another logistics object. In this case, the information with which the logistics backbone system 10 responds to the request 16 may include or be determined from the information related to the another logistics object. The system 10 may obtain this information by for instance sending, to the other logistics backbone system 20, a request for information related to the another logistics object, and receive, from the another logistics backbone system 20, the information related to the another logistics object in response to sending the request.

In these and other embodiments, therefore, the end device 14 may need to simply connect to one logistics backbone system 10, in order to retrieve information 18 that is directly or indirectly related to a certain logistics object 12 across multiple hierarchical levels, even though that information may be distributed across multiple decentralized logistics backbone systems. That is, the connected nature of the backbone systems may remain transparent to the end device 14.

Processes performed by a logistics backbone system 10 may therefore include relating a globally unique identifier 12A to certain information 18, and/or serving information requests 16 concerning a globally unique identifier 12A. The system 10 may relate a globally unique identifier 12A to certain information 18 by for example receiving from an end device 14 a certain globally unique identifier 12A and information 18 that is to be associated with that identifier 12A in the backbone system's database(s) 10B. The system 10 may then store that information 18 in the database(s) 10B in relation to the certain identifier 12A. The information 18 may be certain data fields (e.g., route, destination, name of vehicle, etc.) and/or one or more other globally unique identifiers that are to be related to the certain identifier 12A in a hierarchy. The system 10 in the latter case may for instance receive information relating two identifiers in a hierarchy of global identifiers.

The system 10 may serve information requests by for example receiving from an end device 14 a request 16 for information 18 related to a certain global identifier 12A, and then serving that information 18 to the end device 14 as requested. The information 18 again may be certain data fields and/or one or more other global identifiers.

In some embodiments, the backbone system 10 may verify that an end device 14 that wants to update or fetch information directly is a trusted device, e.g., by asking that device's home backbone system if the device is approved.

Alternatively or additionally, the backbone system 10 may keep track of the present hierarchy in which a globally unique logistics identifier is included in. The system 10 may for example keep a session record of which parent-child relationships are valid at present.

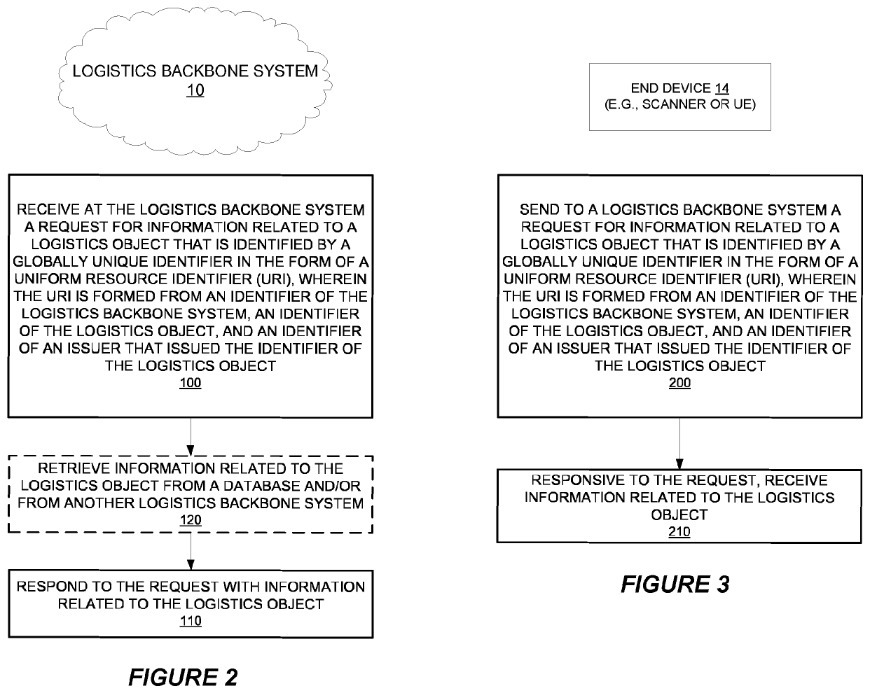

In view of the above, FIG. 2 generally shows a method performed by a logistics backbone system 10 according to some embodiments. As shown, the method comprises receiving at the logistics backbone system 10 a request 16 for information 18 related to a logistics object 12 (e.g., a transport unit, a product, a product package, a freight container, or a movement vehicle) (Block 100). The requested information 18 related to the logistics object 12 may be for instance information describing content of the logistics object, information describing handling instructions for the logistics object, information describing a source and/or destination of the logistics object, information describing a route taken by the logistics object, or information describing a status of an event related to the logistics object. Regardless, the logistics object 12 may be identified by a globally unique identifier 12A in the form of a uniform resource identifier (URI). The request 16 may be addressed to the URI in some embodiments. Regardless, the URI may be formed from an identifier 14A of the logistics backbone system 10, an identifier 14B of the logistics object 12, and an identifier 14C of an issuer that issued the identifier 14B of the logistics object 12. In some embodiments, the method further comprises responding to the request 16 with information 18 related to the logistics object 12 (Block 110).

In some embodiments, the method may comprise retrieving the information 18 related to the logistics object from a database 10B of the logistics backbone system 10 (Block 120). In some embodiments, for instance, the method may comprise retrieving from a database 10B of the logistics backbone system 10 information 18 that is related to the logistics object 12 by way of the information describing the logistics object itself.

Alternatively or additionally, the method may comprise retrieving the information 18 related to the logistics object from another logistics backbone system (Block 120). This may be the case for instance in some embodiments where the logistics backbone system 10 is one of multiple decentralized logistics backbone system. In one embodiment, at least some of these multiple decentralized logistics backbone systems provide logistics information for multiple different logistics hierarchical levels, respectively. In these and other embodiments, then, the method may comprise retrieving from another logistics backbone system information that is related to the logistics object by way of the information describing another logistics object that is hierarchically related to the logistics object.

More particularly, in some embodiments, the method further comprises determining that the logistics object 12 is hierarchically related to another logistics object that is also identified by a globally unique identifier in the form of a URI. In this case, the method may also comprise obtaining information related to the another logistics object using the globally unique identifier of that another logistics object. In some embodiments, for instance, obtaining the information related to the another logistics object may involve sending, from the logistics backbone system 10 to another logistics backbone system, a request for information related to the another logistics object, the request addressed to the URI that forms the globally unique identifier of the another logistics object. The obtaining may further involve receiving, at the logistics backbone system 10 from the another logistics backbone system, the information related to the another logistics object in response to sending the request. No matter how the information related to the another logistics object is obtained, though, the information 18 with which the logistics backbone system 10 responds to the request 16 may include or be determined from the information related to the another logistics object.

FIG. 3 shows a corresponding method performed by an end device 14 (e.g., a scanner or UE) according to some embodiments. The method may comprise sending to a logistics backbone system 10 a request 16 for information 18 related to a logistics object 12 (e.g., a transport unit, a product, a product package, a freight container, or a movement vehicle) (Block 200). The requested information 18 related to the logistics object 12 may be for instance information describing content of the logistics object, information describing handling instructions for the logistics object, information describing a source and/or destination of the logistics object, information describing a route taken by the logistics object, or information describing a status of an event related to the logistics object. Regardless, the logistics object 12 may be identified by a globally unique identifier 12A in the form of a uniform resource identifier (URI) (Block 200). The request 16 may be addressed to the URI in some embodiments. Regardless, the URI may be formed from an identifier 12A of the logistics backbone system 10, an identifier 12B of the logistics object 12, and an identifier 12C of an issuer that issued the identifier 12B of the logistics object 12. The method may further comprise, responsive to the request 16, receiving information 18 related to the logistics object 12 (Block 210).

In some embodiments, the information 18 is related to the logistics object by way of the information describing the logistics object itself. Alternatively or additionally, the information 18 may be related to the logistics object by way of the information describing another logistics object that is hierarchically related to the logistics object 12. This may be the case for instance in some embodiments where the logistics backbone system 10 is one of multiple decentralized logistics backbone system. In one embodiment, at least some of these multiple decentralized logistics backbone systems provide logistics information for multiple different logistics hierarchical levels, respectively.

In fact, in some embodiments, the information 18 related to the logistics object 12 includes a globally unique identifier of another logistics object to which the logistics object 12 is hieratically related (e.g., as a parent or child of the logistics object 12). For example, the globally unique identifier of the another logistics object may comprise a URI formed from an identifier of the same or a different logistics backbone system, an identifier of the another logistics object, and an identifier of an issuer that issued the identifier of the another logistics object. Regardless, the method in these cases may further comprise sending a request to another logistics backbone system to retrieve information that is related to another logistics object.

Embodiments also include a method performed by a logistics backbone system. The method may comprise obtaining information related to a logistics object that has a globally unique identifier in the form of a uniform resource identifier (URI). The URI may be formed from an identifier of the logistics backbone system, an identifier of the logistics object, and an identifier of an issuer that issued the identifier of the logistics object. The method may also include storing the information in a database as being related to the logistics objects that has the globally unique identifier.

One or more embodiments will now be described with occasional reference to certain identification standards, problems, or contexts.

Known logistics approaches don't consider a multi-entity environment where there is a need to share not only the transport unit identification but also additional information with regards to the transport unit. As follows, it is difficult to identify a box and do global track & trace as an example. Furthermore, due to the changing nature of the logistics object that should be tracked, all information that should be available throughout the supply chain needs to constantly be inserted into different logistical hierarchies and later on removed from these hierarchies. As a result, all the information needed subsequently has to be attached physically to the box or passed on sequentially through the above mentioned electronic technologies instead of being available when needed.

Known approaches therefore causes duplication of records and a lot of manual and physical documentation in each hand-over in the supply chain. In addition, other effects are the loss of information, bad quality, waste of paper, and longer lead-times. Also, known approaches need business-to-business connectivity on a peer-to-peer basis, which lately has proven to be an increasing obstacle considering the number of actors in the logistics industry. Taken a simple example of 10 shippers, 10 forwarders, 3 trucking companies, and 20 carriers would result in 6000 peer-to-peer connections. Therefore, the logistics industry has had slow progress in adapting to an increasingly digitized world and is under attack from new companies that need faster, more integrated solutions. Moreover, a few companies have heretofore dominated the communication flow in some of the logistics industry, which causes inhibitors to the market functioning fully to the benefit of all market participants.

One or more embodiments herein combine 3 layers of identification: the transport unit (cargo), the entity creating the transport unit, and the address where the source of related information such as content, commodity, handling instructions, etc. is stored in the cloud. Some embodiments accordingly encompass 3 areas of standards: the URI standard RFC3986, the License Plate standard ISO15459, and the ISO15459 Transport Unit, creating a unique URI as the identity of a logistics information object. For example, a unique URI identifying a logistics information object may be www.shipper.com/connected_logistics/companyA/box_identifier123, formed from an identifier of the transport unit (box_identifier123), an identifier of the entity creating the transport unit (companyA), and an address where the source of related information is stored (www.shippercom/connected_logistics/companyA/box_identifier123). The combination of these 3 layers of identification makes the identifier unique in the whole world. The identifier may therefore be referred to as a globally unique identifier or a global unique logistics identifier. In addition, one or more embodiments add related attributes to the global unique logistics identifier which are needed in the supply chain for collaboration purposes. These may be event status, additional required product information for governmental and customs purposes, etc.

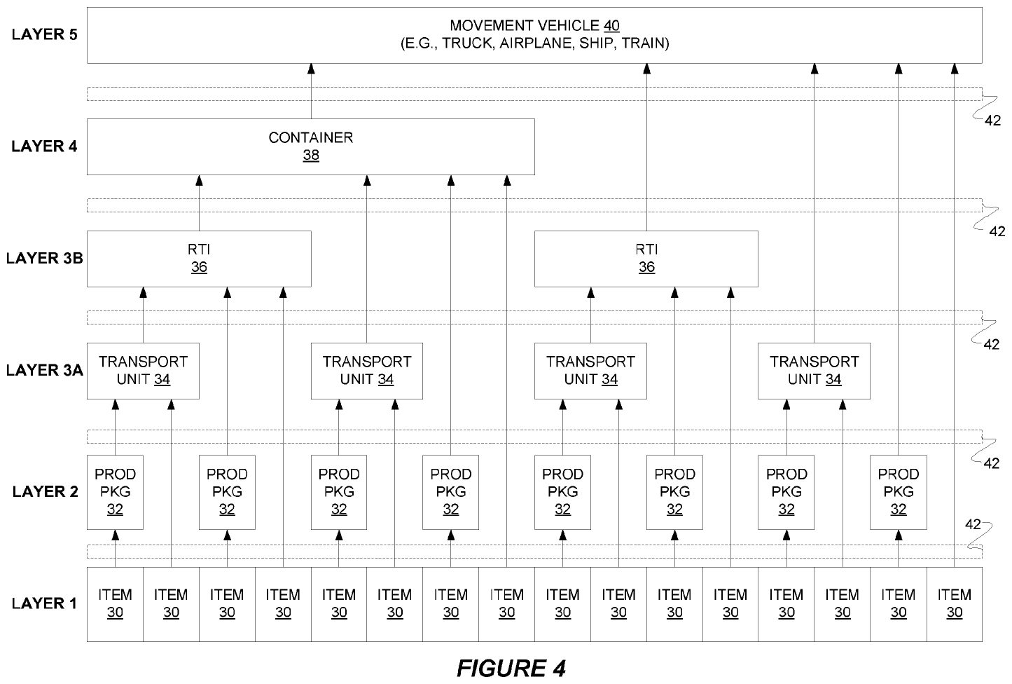

Some embodiments however extend a globally unique identifier to any object in the supply/logistics chain, not just transport units. FIG. 4 in this regard illustrates the consolidation process used fully or partially within a logistic chain according to some embodiments. As shown, an item 30 (e.g., a product) may be included at Layer 1 of a logistics hierarchy. An item 30 may be identified for instance by an RFID according to ISO 17367 and by a bar code (BC) according to ISO 28219. An item 30 may be consolidated into a product package 32 at Layer 2 of the hierarchy. Product packages 32 may be identified for instance by an RFID according to ISO 17366 and by a bar code according to ISO 22742. Product packages 32 or items 30 themselves may in turn be consolidated into a transport unit 34 (e.g., an unbreakable unit via which one or more products are transported) at Layer 3A of the hierarchy. A transport unit 34 may be identified for instance by an RFID according to ISO 17386 and by a bar code according to ISO 16394. Transport units 34, product packages 32, or items 30 themselves may be consolidated into a returnable transport item (RTI) 36 at Layer 3B of the hierarchy. RTIs 36 may be identified for instance by an RFID according to ISO 17354 and by a bar code according to ISO 15459-S. RTIs 36, transport units 34, product packages 32, or items 30 themselves may be consolidated into a (freight) container 38 (e.g., a 20/40 foot Marine or a multi-modal container) at Layer 4 of the hierarchy. Containers 38 may be identified for instance by an RFID according to ISO 17363. Finally, containers 38, RTIs 36, transport units 34, product packages 32, or items 30 themselves may be consolidated into a movement vehicle 40 (e.g., a truck, airplane, ship, or train) at Layer 5 of the hierarchy.

In order to address the consolidation mentioned above, some embodiments introduce a global logistic unique identifier on any object in the supply chain. That is, a globally unique identifier according to some embodiments may reference any of the logistics objects in FIG. 4. So the logistics object may be a box, a container, an airplane, and so on. Alternatively or additionally, a globally unique identifier may reference a pure informational object. In some embodiments, therefore, a logistics object is any object in FIG. 4 or a pure informational object in the logistical supply chain.

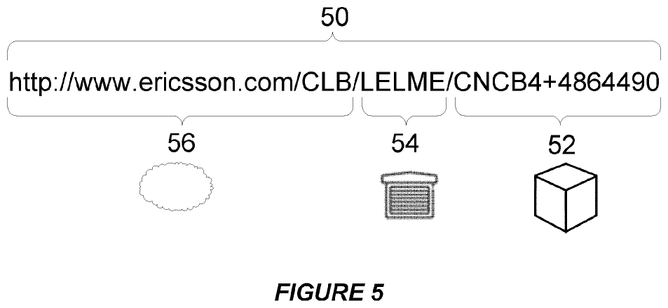

As shown in FIG. 5, the global logistics unique identifier in some embodiments consists of 3 layers of identification: a unique logistics identifier 52 (e.g., a transport unit identifier), a logistics issuer identifier 54 (e.g., identifying the issuer of the logistics identifier 52), and the logistics backbone identifier 56. Through this string of identification, a globally unique logistics identifier 50 is formed that can be used for collaboration in the supply chain.

In more detail, the unique logistics identifier 52 may be governed by global standards such as ISO 15459, GS1 Serial Shipping Container Code (SSCC), and EDIFICE. Where the unique logistics identifier 52 is a transport unit identifier, for example, the identifier 52 may be an ANSI data identifier 1J, which is a unique license plate number assigned to a transport unit (the lowest level of packaging, the unbreakable unit). ANSI data identifier 1J may have be for example two alphanumeric characters followed by from 1 to 35 alphanumeric characters (e.g., of the form an2+an1 . . . 35). The logistics issuer identifier 54 may be governed by global standards such as ISO 15459, EDIFICE license plate, and GS1 Global Location Number (GLN). For instance, the logistics issuer identifier 56 may be an ANSI data identifier 18V, which is an identification of a party to a transaction in which the data format consists of two concatenated segments. The first segment is the Issuing Agency Code (IAC) in accordance ith ISO/IEC 15459. The second segment is a unique entity identification Company Identification Number (CIN) assigned in accordance with rules established by the issuing agency. Finally, the logistics backbone identifier 56 may be a URI and governed by global standard RFC 3986. The logistics backbone identifier 56 may be an ANSI data identifier 33L, which is a Uniform Resource Location (URL) including all characters that form a URL. With these identifiers combined together, the overall globally unique identifier 50 may also be a URI (e.g., an ANSI data identifier 33L).

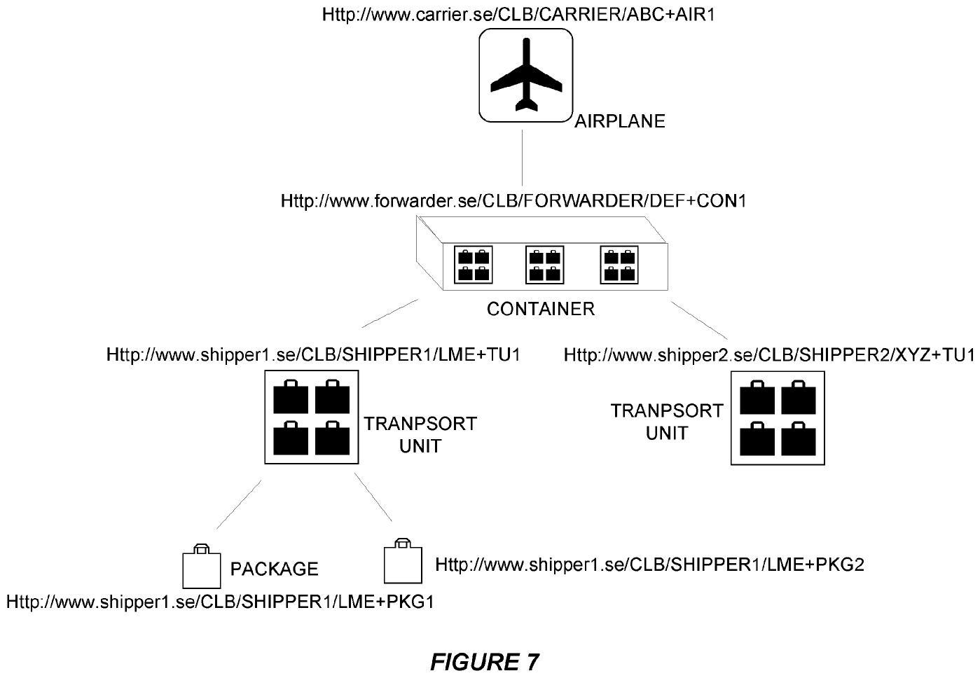

FIGS. 6 and 7 show different possible globally unique identifiers for different logistics objects in a logistics hierarchy according to a simple example. Using any of these globally unique identifiers in the form of a URI, an entity or party can find exactly where more information related to the logistics object is located.

Note that instead of defining levels as in FIG. 7, some embodiments link global logistic unique identifiers from a higher and a lower level. In some embodiments, each domain only knows the needed hierarchy, i.e. lower levels. Through this, some embodiments re-configure the logistics object transported from for example boxes on a pallet in a container on a truck to just being boxes on pallet and start the process over again (i.e., in an iterative process for each hierarchical level).

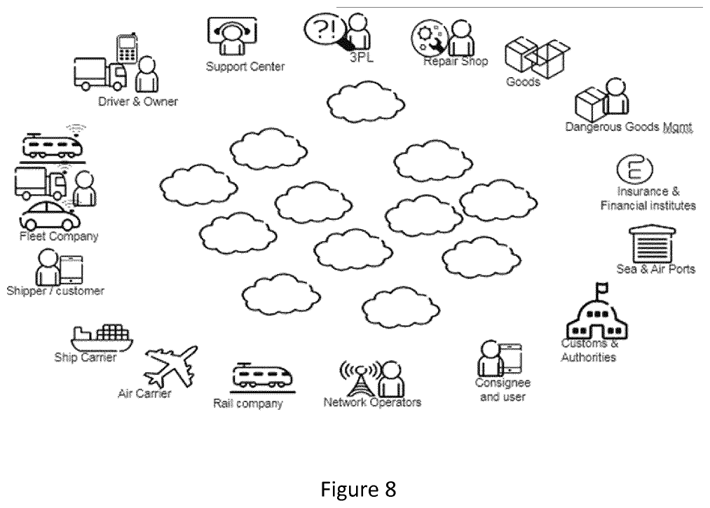

One or more embodiments thereby provide a global unique identifier of a logistics object (e.g., transport unit). This, in connection with a parent-child relationship cascaded through to the parties needed in some embodiments, may solve the issues at hand and provide the fundamentals for a decentralized logistic backbone sharing information when and as needed. This mechanism may be used in a multi-cloud environment, as shown in FIG. 8. That is, the global logistic unique identifier will work in an ecosystem consisting of multiple clouds. Using a cloud solution will provide flexibility and scalability to support the increase or decrease of the logistic market.

Some embodiments enable easy and global reference of logistic identifiers which in turn enable an ecosystem for connected logistics, building on existing internet infrastructure and technology. Furthermore, some embodiments provide a decentralized open platform enabling competition and cooperation within the supply chain for the benefit of all involved parties. Additionally, some embodiments add real-time information sharing without cascading sequential business-to-business connectivity. The business-to-business integration need would also greatly decrease since in some embodiments an entity only need to connect to one connected logistics backbone to have all other actors connected. All these points will lead to greater efficiency, higher quality and lower costs for logistic companies.

Note that embodiments herein may operate using a wireless communication system, which may represent any type of communication, telecommunication, data, cellular, and/or radio network or other type of system. In particular embodiments, the wireless communication system may be configured to operate according to specific standards or other types of predefined rules or procedures. Thus, particular embodiments of the wireless communication system may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards.

Note that a logistics backbone system 10, 20 herein may include any equipment (e.g., server(s), database(s), communication interfaces/links) capable of or configured to operate as described above. The logistics backbone system 10, 20 may for instance include or operate as a web server or to otherwise be accessible via the Internet (e.g., for receiving a request).

A logistics backbone system 10 herein may perform the processing herein by implementing any functional means or units. In one embodiment, for example, the logistics backbone system 10 comprises respective circuits configured to perform the steps shown in FIG. 2. The circuits in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory stores program code that, when executed by the one or more microprocessors, carries out the techniques described herein. That is, in some embodiments memory of the logistics backbone system 10 contains instructions executable by the processing circuitry whereby the logistics backbone system 10 is configured to carry out the processing herein.

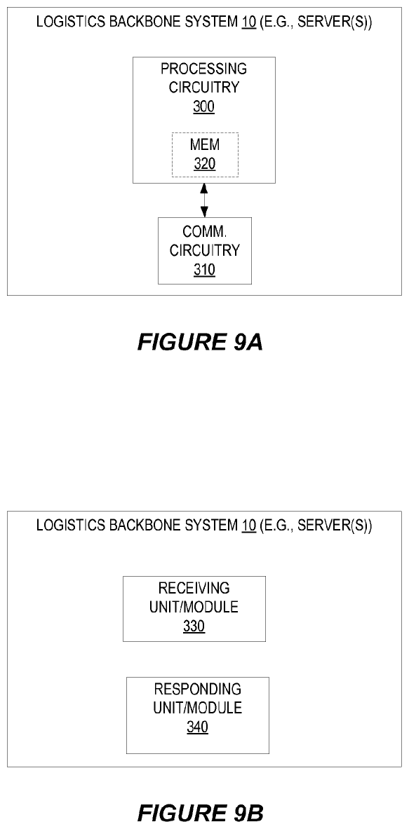

FIG. 9A illustrates additional details of logistics backbone system 10 in accordance with one or more embodiments. As shown, the logistics backbone system 10 (e.g., comprising one or more servers) includes processing circuitry 300 and communication circuitry 310. The communication circuitry 310 is configured to communicate with one or more other nodes, e.g., an end device 14. The communication circuitry 310 may for instance communicate with an end device 14 via one or more wireless communication systems, which may be directly or indirectly accessible to the communication circuitry 310 (e.g., via the Internet). The processing circuitry 300 may be configured to perform processing described above, e.g., in FIG. 2, such as by executing instructions stored in memory 320. The processing circuitry 300 in this regard may implement certain functional means or units.

FIG. 9B in this regard illustrates logistics backbone system 10 in accordance with one or more other embodiments. As shown, the logistics backbone system 10 may include a receiving unit or module 330 and a responding unit or module 340. The receiving unit or module 330 may be for receiving the request 16 as described above. The responding unit or module 340 may be for, responsive to the receiving module 330 receiving the request 16, responding to the request 16. These modules or units 330, 340 may be implemented by the processing circuitry 300 of FIG. 9A.

Also, an end device 14 (e.g., a user equipment) may perform the processing herein by implementing any functional means or units. In one embodiment, for example, the end device 14 comprises respective circuits configured to perform the steps shown in FIG. 3. The circuits in this regard may comprise circuits dedicated to performing certain functional processing and/or one or more microprocessors in conjunction with memory. In embodiments that employ memory, which may comprise one or several types of memory such as read-only memory (ROM), random-access memory, cache memory, flash memory devices, optical storage devices, etc., the memory stores program code that, when executed by the one or more microprocessors, carries out the techniques described herein. That is, in some embodiments memory of the end device 14 contains instructions executable by the processing circuitry whereby the end device is configured to carry out the processing herein.

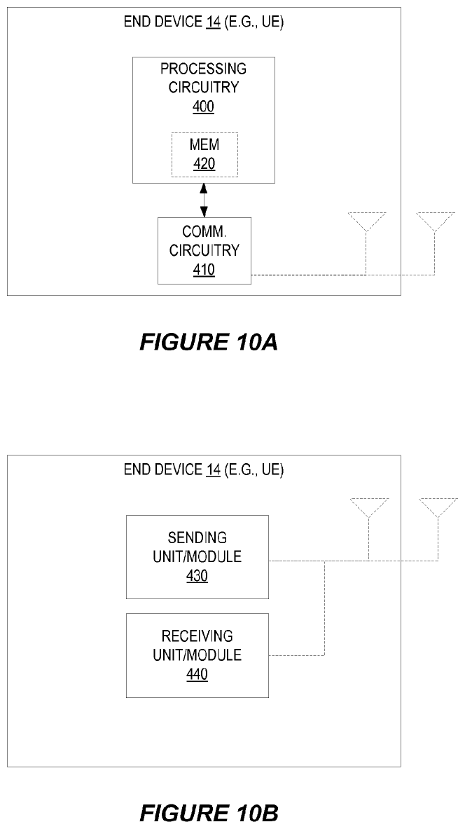

FIG. 10A illustrates additional details of an end device 14 in accordance with one or more embodiments. As shown, the end device 14 includes processing circuitry 400 and communication circuitry 410 (e.g., one or more radio circuits). The communication circuitry 410 may be configured to transmit via one or more antennas that are external or internal to the end device 14. In any event, the processing circuitry 400 in FIG. 10A is configured to perform processing described above, e.g., in FIG. 3, such as by executing instructions stored in memory 420. The processing circuitry 400 in this regard may implement certain functional means or units.

FIG. 10B in this regard illustrates additional details of an end device 14 in accordance with one or more other embodiments. As shown, the end device 14 may include a sending unit or module 430 and a receiving unit or module 440. The sending unit or module 430 may be for sending the request 16 described above, and the receiving unit or module 440 may be for receiving the information 18 responsive to the request 16 as described above. These units or modules may be implemented by the processing circuitry 400 in FIG. 10A.

Embodiments herein further include corresponding computer programs. For example, a computer program according to some embodiments comprises instructions which, when executed on at least one processor (e.g., of logistics backbone system 10 or end device 14), cause the processor to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-25. (canceled)

26. A method performed by a logistics backbone system, the method comprising:
receiving, at the logistics backbone system, a request for information related to a logistics object that is identified by a globally unique identifier in the form of a uniform resource identifier (URI); wherein the request is addressed to the URI; wherein the URI is formed from an identifier of the logistics backbone system, an identifier of the logistics object, and an identifier of an issuer that issued the identifier of the logistics object; and
responding to the request with information related to the logistics object.

27. The method of claim 26, further comprising:
determining that the logistics object is hierarchically related to another logistics object that is also identified by a globally unique identifier in the form of a URI; and
obtaining information related to the another logistics object using the globally unique identifier of that another logistics object;
wherein the information with which the logistics backbone system responds to the request includes or is determined from the information related to the another logistics object.

28. The method of claim 27, wherein the obtaining comprises:
sending, from the logistics backbone system to another logistics backbone system, a request for information related to the another logistics object, the request addressed to the URI that forms the globally unique identifier of the another logistics object; and
receiving, at the logistics backbone system from the another logistics backbone system, the information related to the another logistics object in response to sending the request.

29. The method of claim 26, further comprising retrieving, from a database of the logistics backbone system, information that is related to the logistics object by way of the information describing the logistics object itself.

30. The method of claim 26, further comprising retrieving, from another logistics backbone system, information that is related to the logistics object by way of the information describing another logistics object that is hierarchically related to the logistics object.

31. A method performed by an end device, the method comprising:
sending, to a logistics backbone system, a request for information related to a logistics object that is identified by a globally unique identifier in the form of a uniform resource identifier (URI); wherein the request is addressed to the URI; wherein the URI is formed from an identifier of the logistics backbone system, an identifier of the logistics object, and an identifier of an issuer that issued the identifier of the logistics object; and
responsive to the request, receiving information related to the logistics object.

32. The method of claim 31, wherein the information related to the logistics object includes a globally unique identifier of another logistics object to which the logistics object is hieratically related.

33. The method of claim 32, wherein the globally unique identifier of the another logistics object comprises a URI formed from an identifier of the same or a different logistics backbone system, an identifier of the another logistics object, and an identifier of an issuer that issued the identifier of the another logistics object.

34. The method of claim 26, wherein the information is related to the logistics object by way of the information describing the logistics object itself.

35. The method of claim 26, wherein the information is related to the logistics object by way of the information describing another logistics object that is hierarchically related to the logistics object.

36. The method of claim 26, wherein the logistics object is a transport unit.

37. The method of claim 26, wherein the logistics object is a product, a product package, a freight container, or a movement vehicle.

38. The method of claim 26:
wherein the logistics backbone system is one of multiple decentralized logistics backbone systems;
wherein at least some of the multiple decentralized logistics backbone systems provide logistics information for multiple different logistics hierarchical levels, respectively.

39. The method of claim 26, wherein the information related to the logistics object includes:
information describing content of the logistics object;
information describing handling instructions for the logistics object;
information describing a source and/or destination of the logistics object;
information describing a route taken by the logistics object; and/or
information describing a status of an event related to the logistics object.

40. A logistics backbone system, comprising:
communication circuitry; and
processing circuitry whereby the logistics backbone system is configured to:
receive, at the logistics backbone system, a request for information related to a logistics object that is identified by a globally unique identifier in the form of a uniform resource identifier (URI); wherein the request is addressed to the URI; wherein the URI is formed from an identifier of the logistics backbone system, an identifier of the logistics object, and an identifier of an issuer that issued the identifier of the logistics object; and
respond to the request with information related to the logistics object.

41. An end device, comprising:
communication circuitry; and
processing circuitry whereby the end device is configured to:
send to a logistics backbone system a request for information related to a logistics object that is identified by a globally unique identifier in the form of a uniform resource identifier (URI); wherein the request is addressed to the URI; wherein the URI is formed from an identifier of the logistics backbone system, an identifier of the logistics object, and an identifier of an issuer that issued the identifier of the logistics object; and
responsive to the request, receive information related to the logistics object.
